(19) United States
(12) Patent Application Publication
(10) Pub. No.: US 2010/0162899 A1
(43) Pub. Date: Jul. 1, 2010

(54) PORTABLE BREWING APPARATUS

(76) Inventors: Stephen J. O'Brien, San Jose, CA (US); Yi-Chun Liao, San Jose, CA (US); Stephen Hooper, Los Gatos, CA (US); Benjamin Pei-Ming Chia, Cupertino, CA (US); Jacques Gagne, Los Gatos, CA (US); Ray Gradwohl, San Jose, CA (US); Kenneth Robertson, San Jose, CA (US)

Correspondence Address: Law Office of Kenneth C. Brooks, P.O. Box 321120, Los Gatos, CA, 95032, US

(21) Appl. No.: 12/425,365

(22) Filed: Apr. 16, 2009

Related U.S. Application Data
(60) Provisional application No. 61/141,226, filed on Dec. 29, 2008.

(51) Int. Cl. A47J 31/32

(52) U.S. Cl. 99/302 R

(57) ABSTRACT

A brewing device comprising a brewing system; a handle assembly coupled to the brewing system and containing a source of compressed fluid; and a valve system, coupled to the handle, to selectively place the source of compressed fluid in fluid communication with the brewing system.

### CROSS REFERENCE TO RELATED PATENT APPLICATIONS

The present patent application claims priority to U.S. provisional patent application No. 61/141,226 filed Dec. 29, 2008, entitled PORTABLE BREWING DEVICE AND METHOD OF MAKING AND OPERATING and having Stephen James O'Brien, Jacques Gagne, Stephen Hoober, Benjamin Pei-Ming Chia; Yi Chuan Liao; Donna Liao; Ray Gradwohl; and Kenneth Robertson listed as inventors; and claims priority to U.S. patent application Ser. No. 12/137,533, filed Jun. 11, 2008 which claims priority to U.S. provisional patent application No. 60/934,294, filed Jun. 11, 2007.

### FIELD OF THE INVENTION

The invention relates to an apparatus and method for brewing beverages. More particularly, the present invention relates to a portable apparatus for brewing beverages by passing heated liquid through a collection of ground beans.

### BACKGROUND OF THE INVENTION

First consumed in the ninth century, the beverage coffee has spread throughout the globe to be one of the largest traded commodities in modern times. Several devices have been developed to prepare the coffee beverage that typically requires brewing ground roasted coffee beans.

One such device is a percolating device that forces boiling water into a chamber above a filter by pressurized steam. The water then passes through the grounds due to gravity, repeating the process until shut off by an internal timer or, more commonly, a thermostat that turns off the heater when the entire pot reaches a certain temperature.

Coffee may also be brewed by steeping in a device such as a coffee press in which ground coffee beans and hot water are combined and left to brew for a few minutes. A plunger is then depressed to separate the coffee grounds from the water. Because the coffee grounds are in direct contact with the water, all the coffee oils remain in the beverage, making it stronger and leaving more sediment than in coffee made by an percolating device.

An espresso device produces one of the more popular coffee beverages. The espresso device forces heated pressurized water through ground coffee beans. As a result of brewing under high pressure the coffee beverage produced by this device, an espresso beverage, is more concentrated than the coffee beverage produce by the percolator device or the coffee press device. Additionally, the espresso device produces a much desired crema.

The science and physical requirements for producing a good espresso are well known to those versed in the art. They include high pressures of approximately 130 psi-240 psi. Water temperature typically in a range of 197° F.-205° F., and the coffee beans freshly roasted and ground within at least two weeks of the brewing process. Espresso is obtained by traversing hot water through coffee grounds for no longer than 25-30 seconds. Failure to meet any of these requirements can result in an express beverage that may be lacking in taste, too bitter to the taste, or that may be lacking sufficient crema in part or in whole. The water temperature can be controlled. Since the heated water typically is prepared close to the natural boiling point of water at sea level, it can be used to deliver a consistent pressure required to produce a good espresso. Most espresso machines, however, are heavy and bulky due to the high-pressure water pumps and pipes, pressure bypass valves and other engineering requirements incorporated into the device.

Whereas the coffee press and percolating devices can be made small and portable, espresso-based beverages are increasingly popular and are typically made with large, non-portable equipment. There is a need, therefore, for an espresso device with an acceptable footprint and operation that facilitates portability of the same.

### BRIEF SUMMARY

A brewing apparatus, comprising a brewing system; a handle assembly coupled to the brewing system and containing a source of compressed fluid; and a valve system, coupled to the handle, to selectively place the source of compressed fluid in fluid communication with the brewing system.

### BRIEF DESCRIPTION OF THE DRAWINGS

FIG. 1 is a perspective view of the a portable brewing device in accordance with the present invention;

FIG. 2 is a perspective view showing a frame of the device shown in FIG. 1;

FIG. 3 is a cross-sectional view of the portable brewing device shown in FIG. 1 taken along lines 3-3;

FIG. 3 is a schematic view demonstrating the operation of a back-flow-valve shown in FIG. 1, in accordance with the present invention;

FIG. 4 is an exploded view of vessels of a fluid injection assembly shown in FIG. 3;

FIG. 5 is an exploded view of a fluid injection assembly shown in FIG. 3;

FIG. 6 is an exploded view of the fluid propagation control system shown in FIGS. 3 and 5;

FIG. 7 is a detailed cross-sectional view of a handle assembly, shown in FIG. 3, taken along lines 7-7, demonstrating the position of components contained therein with a trigger assembly placed in a first trigger configuration;

FIG. 8 is a detailed cross-sectional view of a handle assembly, shown in FIG. 3, demonstrating the position of components contained therein with a trigger assembly placed in a first trigger configuration;

FIG. 9 is a detailed cross-sectional view of a handle assembly, shown in FIG. 7 demonstrating the position of components contained therein with a trigger assembly placed in a second trigger configuration;

FIG. 10 is a detailed cross-sectional view of a handle assembly, shown in FIG. 4, demonstrating the position of components contained therein with a trigger assembly placed in a second trigger configuration;

FIG. 11 is a detailed cross-sectional view of a handle assembly, shown in FIG. 7, demonstrating the position of components contained therein with a trigger assembly placed in a third trigger configuration; and

FIG. 12 FIG. 11 is a detailed cross-sectional view of a handle assembly, shown in FIG. 3, demonstrating the position of components contained therein with a trigger assembly placed in a third trigger configuration.

### DETAILED DESCRIPTION

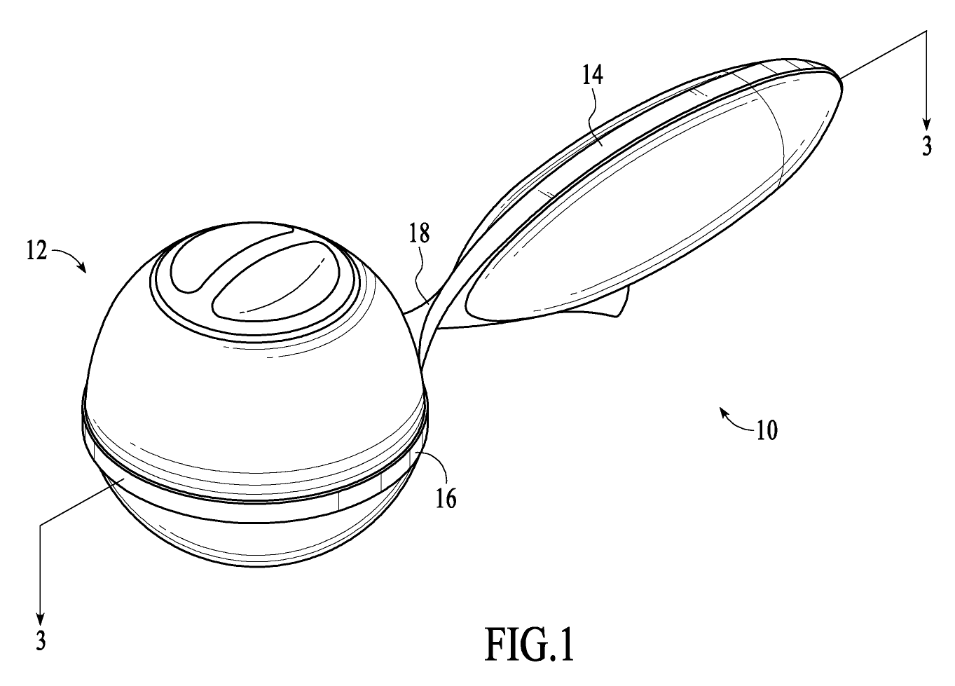

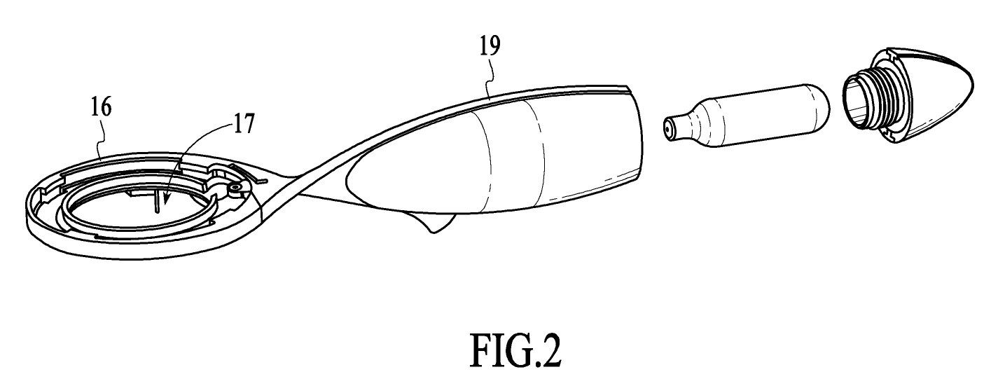

Referring to both FIGS. 1 and 2, shown is a portable brewing apparatus 10 that includes a brewing system 12, a handle assembly 14 an annular frame 16 having a central throughway 17 and a shaft 18. Shaft 18 is integral with annular frame 16 and a body 19 that defines a bulwark of handle assembly 14. Shaft 16 extends between frame 16 and handle assembly 14. Annular frame 16, shaft 18 and body 19 are typically formed from a metal that may be machined or die-cast, such as aluminum, steel and the like.

Referring to FIGS. 1, 2 and 3, brewing system 12 includes a collection assembly 20 and a fluid injection assembly 22 each of which is mounted to frame 16, using a bayonet mounting system. Collection assembly 20 and fluid injection assembly 22 are mounted to opposing sides of annular frame 16. Collection assembly 20 includes a hemispherically-shaped wall 24 extending from a circular opening 26 terminating opposite to frame 16, defining a collection chamber 28. Circular opening 26 is in superimposition with central throughway 17. Disposed within both central throughway 17 and circular opening 24 is a receptacle 30. Receptacle 30 extends from an annular shoulder 32 and terminates in a nadir surface 34 spaced-apart from circular opening 24. Annular shoulder 32 has a diameter that is slightly larger than the diameter of central throughway 17. In this manner, annular frame 16 supports annular shoulder 32 so that nadir surface 34 is disposed within collection chamber 28, spaced-apart from wall 26 when receptacle 30 is seated in collection assembly 20. Nadir surface 34 includes a plurality of through-holes (not shown). Typically hemispherically-shaped wall 24 is formed from a lightweight material, such as plastic and receptacle 30 is formed from metal, such as, aluminum, steel and the like. Formed into wall 24, opposite to circular opening 26, is a fluid exhaust port 36. Fluid exhaust port 36 may be configured to facilitate removal, from collection chamber 28, of liquid passing through nadir surface 32. To that end, fluid exhaust port 36 may be any shape desired, including shapes that are be compatible with well known espresso brewing device accessories and is typically formed from a metal, such as aluminum, steel and the like. A rubber sleeve 38 covers portion of wall 24. Wall 24 and receptacle 30 are formed from any suitable material such as aluminum, steel, plastic and the like.

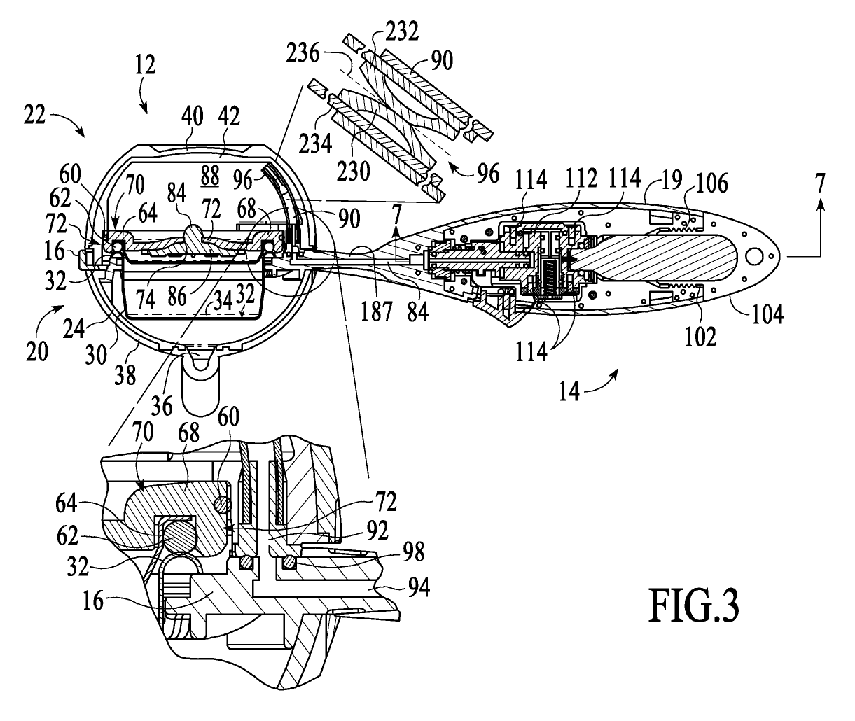

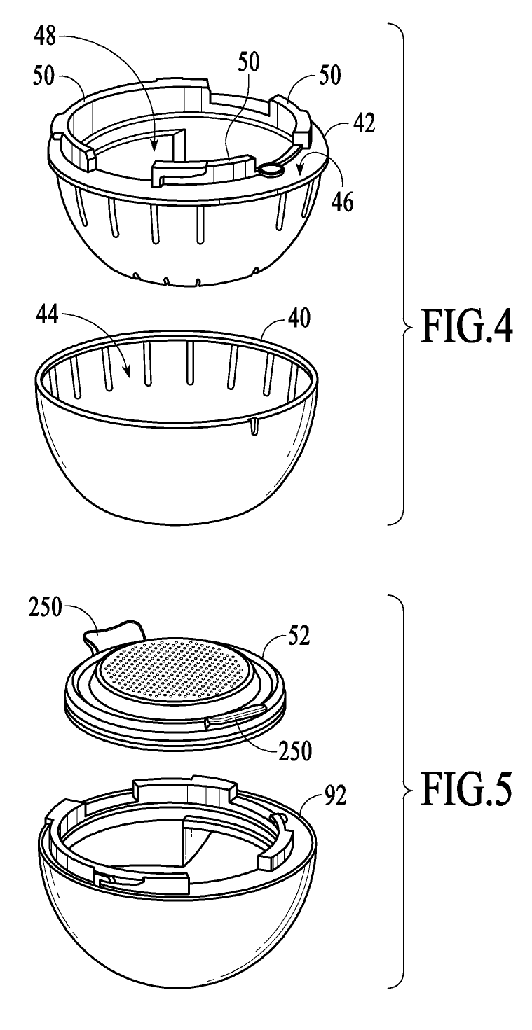

Referring to both FIGS. 3 and 4, fluid injection assembly 22 includes a pair of hemispherically-shaped bodies, cover 40 and pressure vessel 42, having complementary shapes. Cover 40 defines a recess 44 and is shaped and sized appropriately with respect to pressure vessel 42 so that pressure vessel 42 is received therein. Cover 40 is typically formed from plastic and pressure vessel 42 is typically formed from a metal, such as, aluminum, steel and the like. Pressure vessel 42 includes an annular surface 46 that defines an opening 48. Extending from annular surface 46 are a plurality of spaced-apart projections 50 configured to facilitate coupling of pressure vessel 42 to annular frame 16 using a bayonet mounting technique.

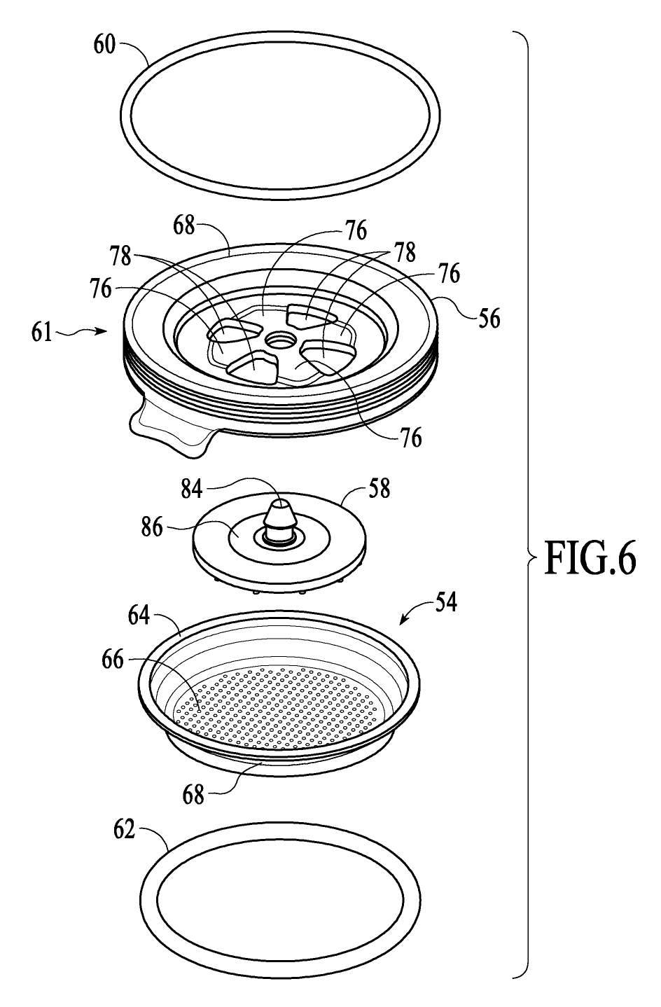

Referring to FIGS. 5 and 6, also included in with fluid injection assembly 22 is a fluid propagation control system (FPC) 52 configured to cover the entire cross-section area of opening 48 when in superimposition therewith. FPC system 52 includes a showerhead 54, a fluid manifold 56 and a flexible membrane 58 disposed between fluid manifold 56 and showerhead 54. First and second FPC O-rings 60 and 62 are included with FPC system 52. O-rings 60 and 62, as with any O-rings mentioned below, may be fabricated from any suitable material such as buna-N, silicone and the like.

Referring to both FIGS. 3 and 6, showerhead 56 includes a circular shoulder 64 and extends therefrom terminating in a circular screen portion 66 having a plurality of through holes that allows fluid, such as heated water, to pass therethrough and impinge upon nadir surface 34. Seccond FPC O-ring 62 is positioned against shoulder 64.

Fluid manifold 56 has a circular shoulder region 68 with a first surface 70 facing away from showerhead 54 and a second surface 72 extending transversely to first surface 70. Shoulder 68 is radially and symmetrically disposed about a membrane coupler 72 and has an opening 74. Extending from membrane coupler 72 are a plurality of spaced-apart spokes 76, each pair of which defines a passageway 78 through which fluid may traverse. A first annular recess 80 is formed into second surface 72 proximate to first surface 70. A second annular recess 82 is formed in shoulder 68 opposite first surface 70 and extends away therefrom. First FPC O-ring 60 is disposed in first recess 80. Circular shoulder 64 and first FPC O-ring 60 is disposed in second annular recess 80. Fluid manifold 56 is typically fabricated from plastic, but may be fabricated from any suitable material such as aluminum, steel and the like.

Flexible membrane 58 includes a centrally disposed detent 84 extending from a flexible region 86 and is received in opening 74 forming an interference fit with membrane coupler 72. Flexible region 86 has sufficient area to be in superimposition with spokes 76 and passageways 78. When FPC system 52 is disposed in opening 48 a chamber 88 is defined by FPC system 52 and pressure vessel 42.

With collection assembly 20 and fluid injection assembly 22 both mounted to annular frame 16, a fluid-tight seal is formed by first FPC O-ring 60 and both pressure vessel 42 and second surface 72; and a fluid-tight seal is formed between second FPC O-ring 62 and both shoulders 80 and 32. Fluid is allowed to ingress into chamber 88 by coupling one end of a flexible passageway 90, which may be in the form of surgical tubing, to a coupling orifice 92 coupled to into annular frame 16. Coupling orifice 92 places flexible passageway 90 in fluid communication with a channel 84 formed into neck 18. As shown, coupling orifice 92 is positioned between pressure vessel 42 and PFC system 52 with flexible passageway 90 extending therefrom away from PFC system 52 juxtaposed against pressure vessel 42 and matching a profile thereof, terminating in backflow valve 96. Backflow valve 96 is received within one end of flexible passageway 90, disposed opposite to coupling orifice 92, forming an interference fit therewith. To maintain fluid-tight integrity between annular frame 16 and coupling orifice 92 a gasket 98 is disposed therebetween that is formed from any suitable material such as buna-N, silicone and the like.

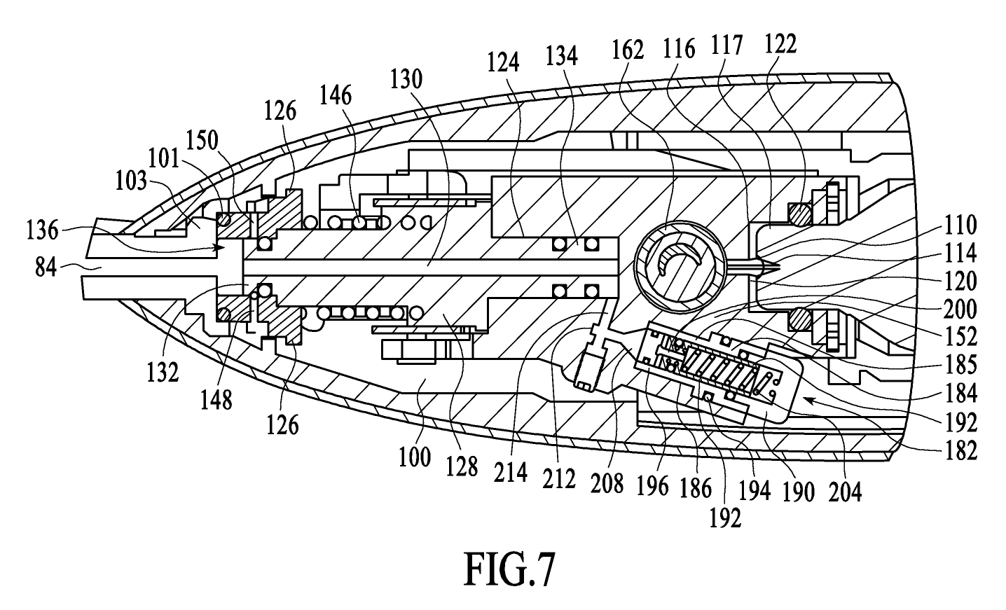

Referring to both FIGS. 3 and 7, body 19 of handle assembly 14 defines a void 100 in which a pressure regulation system (PRS) is disposed. At one end of void 100, disposed opposite to brewing system 12, is an opening defined by a threaded surface 102. A removable terminus 104 has a threaded surface 106 with a profile matching threaded surface 102 by which to couple and decouple terminus 104 with respect to body 19. Both threaded surfaces 102 and 106 may be formed from the same materials used to form frame 19, e.g., metal that may be machined or die-cast. PRS includes a fluid container 108 that extends from terminus 104, terminating in a frangible seal 110, disposed between neck 18 and terminus 104, which typically houses compressed fluid and is formed from a metal, such as aluminum, steel and the like. Also included in PRS is a bulwark 112 coupled to body 19 with a plurality of fasteners, shown as screws 114. Bulwark 112 may be formed from the same materials used to form frame 19, e.g., metal that may be machined or die-cast. A portion of bulwark 112 facing frangible seal 110 includes a first bulwark recess 116 in which one end 117 of fluid container 108 is received. Extending from first bulwark recess 116 is a hollow piercing implement 118 having a channel 120. When terminus 104 is threaded onto body 19 piercing implement 118 breaks frangible seal placing an inner chamber (not shown) of fluid container 108 in fluid communication with channel 120. Surrounding end 117 is an O-ring 122 forming a fluid-tight seal between end 117 and bulwark 112.

A second bulwark recess 124 is formed in bulwark 112, opposite to first bulwark recess 116. PRS also includes a bearing member 126 and a valve body 128. Bearing member 126 is fixedly attached to body 19 using any suitable means, such as fasteners (not shown) so as to be spaced-apart from bulwark 112, facing second bulwark recess 124. Positioned between bulwark 112 and bearing member 126 is valve body 128. Valve body 128, typically formed from a metal such as brass, bronze and the like, has a central throughway 130 extending along a longitudinal axis (not shown) thereof. Projections extend from opposed ends of valve body 128 and are radially and symmetrically disposed about central throughway 130, defining first and second valve elements 132 and 134. Bearing member 126, typically formed from the same types of materials as frame 19, e.g., metals that may be machined or die cast, includes a hollow bore 136 extending therethrough, and first valve element 132 is disposed within said hollow bore 136. Surrounding first valve element 132 is an annular O-ring 138 forming a fluid tight seal between bearing member 126 and first valve element 132. A pair of spaced-apart O-rings 140 and 142 surround second valve element 134. O-rings 140 and 142 form a fluid-tight seal between second valve element 134 and bulwark 112. A helical spring 146 is disposed around valve body 128 and resiliently biases the same so that valve element 134 is disposed within second bulwark recess 124. The relative dimensions of valve element 134 and second bulwark recesses 124 are established so that substantially the entire volume of second bulwark recesses 124 is filled by valve element 134. The relative dimensions of valve element 132 and central bore 136 are established so that a portion of the volume of central bore 136 is not filled by valve element 132 when helical spring 146 resiliently biases valve body 128 to have valve element 134 fill the volume of second bulwark recess 124. In this position, referred to as the first trigger configuration, a pair of exhaust ports 148 and 150 are in fluid communication with channel 84 via central bore 136. Ports 148 and 150 place central bore 136 in fluid communication with void 100. To maintain a fluid-tight integrity of central bore 136, an O-ring 101 is disposed between bearing member 126 a neck coupler 103 integrally formed with neck 18.

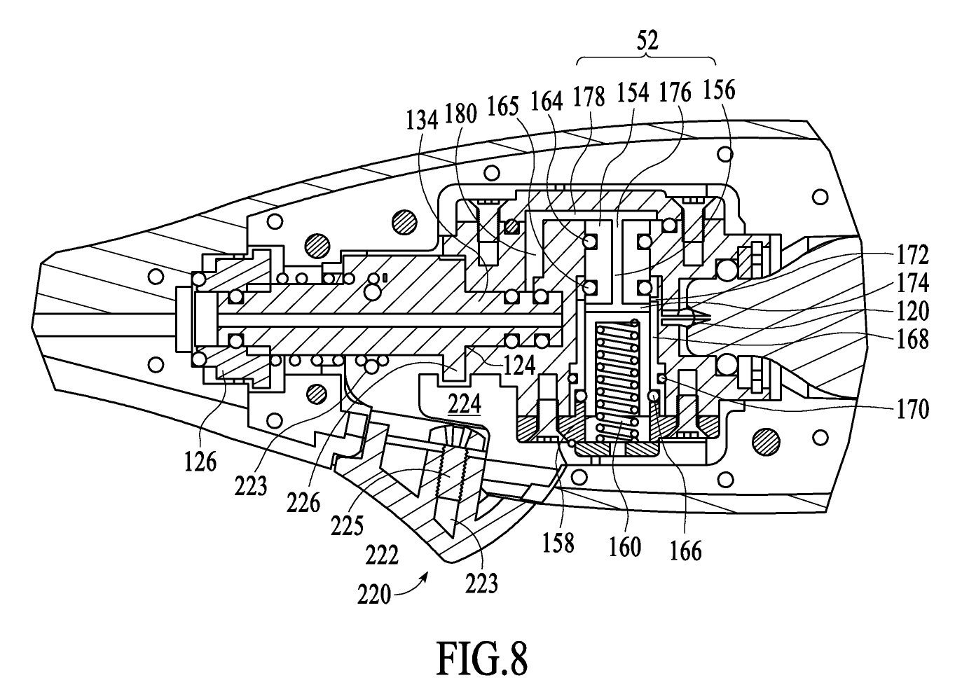

Referring to both FIGS. 7 and 8, also included in PRS, between fluid container 108 and second bulwark recess 124 is a pressure regulator 152. Pressure regulator 152 includes a metal valve body 154, typically formed from a metal such as brass, bronze and the like, machined to have a “T-channel” 156 extending along to orthogonal directions and a hollow recesses 158 in which a helical spring 160 is disposed within hollow recess 158. Valve body 154 is disposed within a hollow chamber 162 of bulwark 112, a plurality of O-rings 164, 165 and 166 surround body 154. A metal sleeve 168, typically formed from a metal such as brass, bronze and the like, is disposed within hollow recess 158 and is surrounded by an O-ring 170 to form a fluid-tight seal between sleeve 168 and bulwark 112. O-ring 164 forms a fluid-tight seal between valve body 154 and bulwark 112. Each of O-rings 165 and 166 forms a fluid-tight seal between valve body 154 and sleeve 168. Sleeve 168 includes an aperture 172 that faces channel 120. A first opening 174 of T-channel 156 faces aperture 172. A second opening 176 of T-channel 156 is disposed opposite to recess 158 and faces away from helical spring 160. Second opening 176 is in fluid communication with a pair of channels 178 and 180 formed into bulwark 112. Channel 180 extends from second bulwark recess 124 and terminate in channel 178 and channel extends from channel 180 and terminates in second opening 176.

Also included in PRS is a maximum pressure regulator (MPR) 182. MPR 182 includes a hollow cylindrical sleeve 184, typically formed from a metal such as brass, bronze and the like, disposed within a bore 186 of bulwark 112. Cylindrical sleeve 184 includes apertures 185 and extends from bore 186, terminating in an opening 188. A venting cap 190, formed from any suitable material, such as aluminum, steel, brass, bronze and the like, covers opening 188 and includes a tapered portion 192 that is inserted into sleeve 184, as well as apertures (not shown) allowing venting into void 100. An O-ring 194 surrounds sleeve 184 and forms a fluid-tight between bulwark 112 and sleeve 184. A portion 196 of sleeve 184 extends from O-ring 194 and has a smaller outside diameter than the remaining portion of sleeve 184. Disposed within sleeve 184 is a metal valve body 198 machined to have a “T-channel” 200 extending along to orthogonal directions and a hollow recesses 202 in which a helical spring 204 is disposed. Valve body 198 is disposed within sleeve 184. A plurality of O-rings 205 and 206 surround body 198 forming a fluid-tight seal between sleeve 184 and valve body 198. Formed into bulwark 112, opposite to cover 190 is a frusto-conically shaped chamber 208 extending from bore 186 and terminating in an opening 210 that is in fluid communication with a butterfly valve 212. Butterfly valve 212 places frusto-conically shaped chamber 208 in fluid communication with a throughway 214 that is in fluid communication with second bulwark recess 124.

Operation of PRS is controlled by movement of a trigger assembly 220 that includes a trigger element 222 connected to body 19 to rotate about pivot 223. Trigger element 222 is coupled to a suitable linkage 224 that facilitates that reciprocates a partial distance between bearing member 126 and bulwark 112. Linkage 224 is coupled to a detent 226 of valve body 128 to move in response to movement of linkage 224.

Trigger assembly 220 is biased to be maintained in a first trigger configuration without any force being applied to trigger element 222. The trigger element 222 includes fastener opening 223 and is fastened to linkage 224 with a fastener, such as a screw 225, which may be adjusted for calibration of switch position. In the first trigger configuration valve bodies 128, 154 and 196 are positioned as shown in FIGS. 7 and 8. As a result, fluid communication between channel 84 and void 100 is maintained via ports 148 and 150, fluid communication between channel 84 and either channel 120 or throughway 214 is precluded. Channel 84 is isolated from channel 120 and throughway.

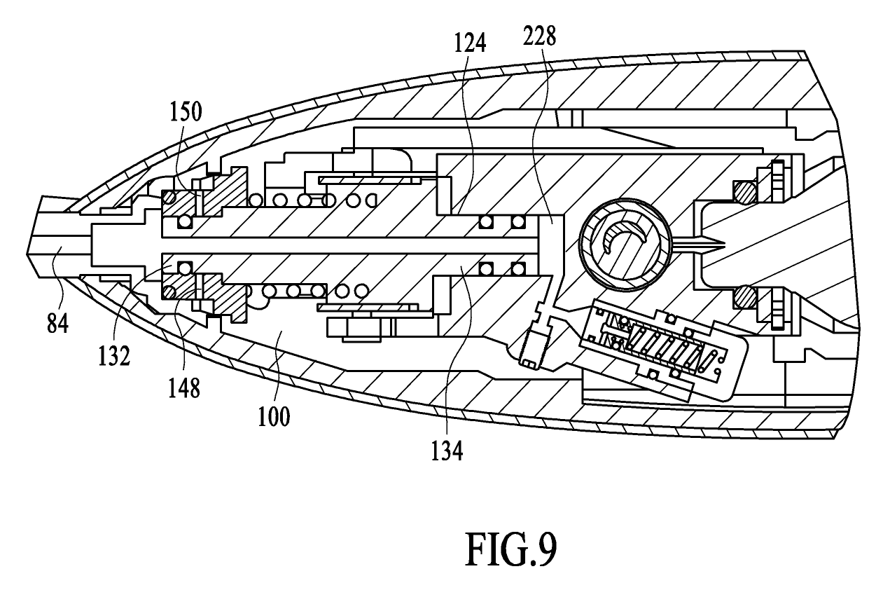

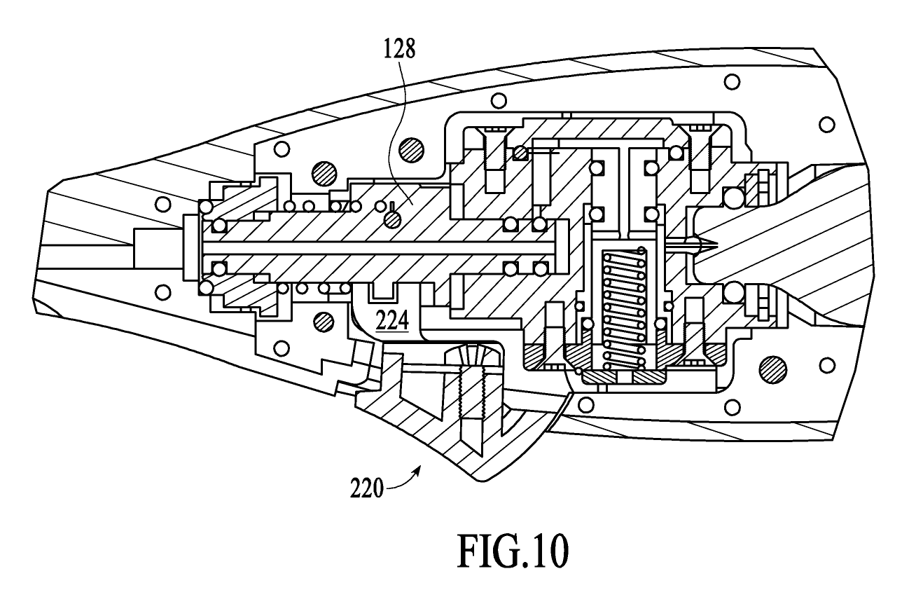

Referring to both FIGS. 9 and 10, with trigger assembly 220 in a second trigger configuration, linkage 224 moves valve body 128 so that valve element 132 covers ports 148 and 150. This isolates void 100 from channel 84 and defines a volume 228 between valve element 134 and second bulwark recess 124.

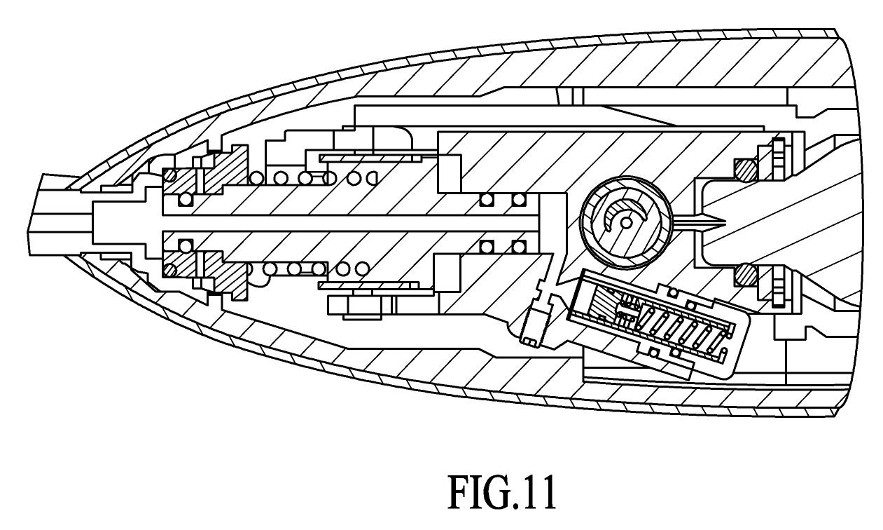

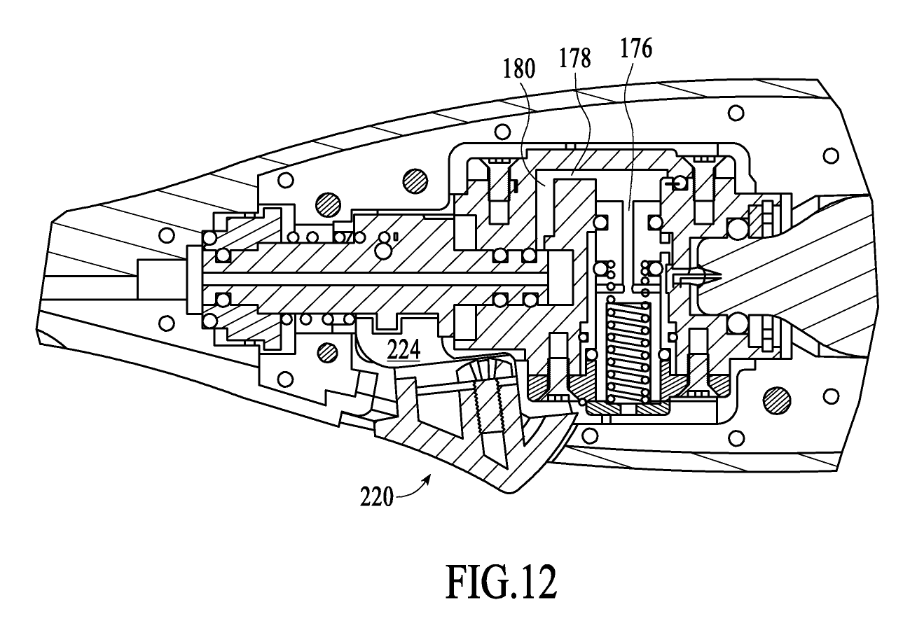

Referring to both FIGS. 11 and 12, with trigger assembly 220 in a third trigger configuration, linkage 224 moves valve body 128 so that valve element 132 central throughway is in fluid communication with channel 180 via chamber 228. As a result, fluid from fluid container 108 is allowed to propagate through channel 84 and into brewing system 12, shown more clearly in FIG. 3. In the third trigger configuration the fluid in channels 180, 178, 176 and 120 is provided a fluid path to brewing system 12. MPR 182 operates to prevent over-pressurization of brewing system 12 by allowing venting of fluids in channels 84, 180, 178, 176, central throughway 130 and chamber 228, referred to as the fluid injection path, into void 100. To that end, were the pressure in fluid injection path to exceed a desired level, valve body 196 would compress spring 204 and move away from frusto-conical chamber 208 allowing fluid to move through T-channel 200 and out through venting cap 190 into void 100.

Referring to FIGS. 8, 15, 17 pressure regulator 152 allows fluid to fill and pressurize channels 180, 178, 176 and 120. This results from piercing implement 118 fracturing frangible seal 110 of fluid container 108. Specifically, fluid container 108 contains a compressed fluid, e.g., carbon dioxide, nitrogen and the like once frangible seal 110 is fractured, pressure regulator 152 is exposed to the compressed fluid. Spring 160 is configured to compress upon the pressure channels 180, 178, 176 reaching a desired level. At which point valve body 154 moves toward trigger element 222 so that O-ring 165 seals aperture 174, effective isolating fluid container 198 from channels 180, 178, 176, shown more clearly in FIG. 12. In the third trigger configuration, the pressurized fluid in channels 180, 178, 176 is allowed to propagate into brewing chamber, shown in FIG. 3. After the pressure decreases in channels 180, 178, 176, valve element 154 moves away from trigger element 222 once again allowing compressed fluids from fluid container 108 to propagate into channels 180, 178 and 176. Pressure regular 152 maintains a substantially constant pressure of fluid propagating into fluid injection assembly 22 by valve element 154 reciprocating back and forth, in this manner, while trigger assembly 220 is in the third trigger configuration.

Referring to FIG. 3, fluid container 108 includes compressed fluids, such as CO₂, N₂, ambient air gases, and the like, at pressure P₀, communicates or is otherwise coupled to pressure regulator 152 to control flow of fluid from fluid container 108 valve element 134. Pressure regulator 152 operates to maintain the pressure of fluid in channels 180, 178 and 176 in a range of 135 to 165 pounds per square inch (psi). Compressed fluid within fluid container 108 is maintained at a second pressure P₁, to provide a baseline pressure for use in controlling the flow of liquid in fluid injection assembly 22 over the grounds in receptacle 30, such as in coffee grounds. Thus, providing fluid at such a pressure would enable apparatus 10 to brew a substance such as espresso at the appropriate pressure required for a quality espresso brew. To that end, heated liquid, such as water, is introduced into fluid injection assembly by removing FPC 52, exposing opening 48. FPC system 523 includes grips 250 to facilitate removal of FPC system 52 from pressure vessel 42. After the heated liquid is introduced, FPC system 52 is mounted to pressure vessel 42, forming an interference fit therewith. The liquid is retained in the vessel by FPC system 52 until the brewing process occurs.

During the brewing process, valve element 132 regulates fluid pressure in fluid injection assembly 22 by activation of trigger assembly 220. In this fashion, a user of apparatus 10 may regulate the quantity of fluid, compressed gas from fluid container 108, introduced into fluid injection assembly 22 to establish a second pressure P₂, which may vary at different stages in the brewing process, where its pressure depends on several different factors in the process. To that end, trigger assembly 220 operations to activate different valving operations of valve elements 132 and 134. MPR valve 182 vents fluids into void 100 in response to the pressure of fluid in fluid injection assembly 22 exceeding approximately 250 psi. Specifically, back flow valve 96 facilitates bidirectional fluid flow between chamber 228 and fluid injection assembly 22 to allow MPR valve 182 to operate as a safety feature and while facilitating a flow of fluid from fluid container 108 into fluid injection assembly 22. To that end, back flow valve 96 is fabricated as a pressure sensitive back/bladder valve that includes two flexible bladder elements 230 and 232 mount to a body 234 that is inserted into tube 90. Bladder elements an arcuate shape, central portions of which extend substantially equidistant from body 234 compressing together proximate to a central axis 236 of body 234. Central portions are spaced apart from body 234 to facilitate separation of bladder 230 and 232 from central axis 236 forming an opening through which fluid may propagate when the pressure of the fluid is of a predetermined pressure. As designed bladder elements 230 and 232 separate from central axis 236 in the present of a fluid pressure of approximately 20 psi. Back flow valve 96 is formed from santopreme.

Flexible membrane 58 functions to retain fluid, such as water, present in fluid injection assembly 22 until chamber 88 reaches a pressure P_{C} that exceeds a predetermined magnitude, e.g., between 135 psi to 145 psi. Once pressure P_{C} is obtained, flexible portion 86 moves away from fluid manifold 56 so that liquid may propagate through showerhead 54 and into collection assembly 20. In this manner, coffer, such as espresso, may be brewed. For brewing espresso, it is desired that pressure P_{C} be consistently over the minimum pressure value in the chamber 88 for a duration of time sufficient to brew the water over the grounds, such as 20-25 seconds for example. The espresso may then be exhausted from collection assembly 20 through exhaust portion 36 and ultimately into a cup or other container. To assist a user trigger assembly 220 may have perceivable indicator, such as a click mechanism, that would aid the user of apparatus 10 in selecting a desired or optimal brewing results.

It should be understood that the description set forth above are examples of the different embodiments of the present invention. Many modifications and changes may be recognized by those of ordinary skill in the art. Therefore, the scope of the invention should not be limited to the description set forth above. Rather, the scope should be determined by the claims including the full scope of equivalents.

1. A brewing device, comprising:
a brewing system;
a handle assembly coupled to the brewing system and containing a source of compressed fluid; and
a valve system, coupled to the handle, to selectively place the source of compressed fluid in fluid communication with the brewing system.

2. A portable brewing device, comprising:
a compressed gas container;
a pressure regulator configured to control the release of gas from the compressed gas container;
a regulated gas vessel configured to hold a gas at a predetermined pressure when released from the pressure regulator;
a flow valve communicating with the pressure regulator that controls the flow of compressed gas into the water vessel.
a water vessel communicating with the flow valve;
a water release valve configured to release water when the water vessel is above a predetermined level;
a grounds vessel communicating with the water vessel and configured to receive water from the water vessel to brew espresso; and
an outlet configured to release espresso produced from water flowing through grounds contained in the grounds vessel when brewing.

3. The device as recited in claim 2 further comprising a safety valve configured to release pressure from the water vessel.

4. The device as recited in claim 3 wherein the gas release mechanism is configured to release compressed gas under the control of the pressure regulator.

5. The device as recited in claim 3 wherein gas release mechanism is configured to access the compressed gas container, allowing the release switch to release compressed gas governed by the pressure regulator.

6. The device as recited in claim 3 wherein the compressed gas container is a pre-compressed and sealed container, and wherein the release valve is a piercing member configured puncture the container to release compressed gas.

7. The device as recited in claim 2 wherein the pressure regulator is a manual control configured to adjust pressure of gas released from the compressed gas container.

8. The device as recited in claim 2 wherein the pressure regulator is configured to control pressure within water vessel.

9. The device as recited in claim 2 wherein the pressure regulator is configured to increase and decrease pressure within water vessel to cause the controlled transfer of water from the water vessel into the grounds vessel.

10. The device as recited in claim 2 wherein the pressure regulator is configured to control pressure within water vessel in a manner to transfer water from the water vessel into the grounds vessel in a controlled manner.

11. The device as recited in claim 10 further comprising a water distributor configured to distribute the water transferred into the grounds vessel in a controlled manner.

12. The device as recited in claim 10 further comprising a water distributor configured to distribute the water transferred into the grounds vessel in a controlled manner to evenly distribute the transferred water over a surface of grounds contained in the grounds vessel.

13. The device as recited in claim 2 further comprising a safety release valve configured to release pressurized gas into a location other than the water vessel upon predetermined conditions.

14. The device as recited in claim 2 wherein the water vessel has a removable lid for adding water.

15. The device as recited in claim 4 further comprising at least one access lid, wherein the safety release valve is configured to prevent pressure from being released from the compressed gas container when the lid is removed.

16. The device as recited in claim 2 wherein the coffee vessel has a removable lid for adding coffee grounds.

17. The device as recited in claim 2 wherein the water vessel and grounds vessel are conjoined and have adjacent openings, the portable espresso maker further comprising a removable lid for giving access to the adjacent openings to add water and grounds.

18. The device as recited in claim 2 further comprising at least one access lid, wherein the safety release valve is configured to prevent pressure from being released from the compressed gas container when the lid is removed.

19. The device as recited in claim 2 further comprising a convenience light configured to illuminate an area about which brewed espresso will be poured.

20. The device as recited in claim 2 further comprising a first lid configured to cover grounds held within the mixing vessel and a second lid configured to cover water held within the water vessel.
